(19) United States
(12) Patent Application Publication
(10) Pub. No.: US 2003/0046701 A1
(43) Pub. Date: Mar. 6, 2003

(54) User interface for mobile platforms and related methods

(76) Inventor: Mary E. O'Donnell, Snoqualmie, WA (US)

Correspondence Address: HARNESS, DICKEY & PIERCE, P.L.C., P.O. BOX 828, BLOOMFIELD HILLS, MI, 48303, US

(21) Appl. No.: 10/162,981

(22) Filed: Jun. 5, 2002

Related U.S. Application Data
(60) Provisional application No. 60/316,458, filed on Aug. 31, 2001.

(51) Int. Cl. H04N 7/20; H04N 7/18

(52) U.S. Cl. 725/76; 725/73; 725/81

(57) ABSTRACT

A user-processor interface is described for providing data content to a user in transit on a mobile platform. The interface includes at least one option selectable by the user for bi-directional access to a network via satellite link. The interface also includes at least one option selectable by the user for real-time access to video content via satellite link. The user interface allows an in-flight passenger to select from an extensive menu of travel-related information, including up-to-date flight and ticketing information pertaining to the airline and aircraft carrying the passenger.

### CROSS-REFERENCE TO RELATED APPLICATIONS

This application claims the benefit of U.S. Provisional Application No. 60/316,458 filed Aug. 31, 2001, which is hereby incorporated by reference in its entirety. This application is a continuation-in-part of U.S. patent application Ser. No. 09/639,912 filed on Aug. 16, 2000, presently pending, the disclosure of which is incorporated herein by reference.

### FIELD OF THE INVENTION

The present invention relates to user interfaces for networked computer systems and more particularly to network system interfaces for mobile users such as airline passengers.

### BACKGROUND OF THE INVENTION

Broadband data and video services have not been widely available to users on mobile platforms such as aircraft, boats, trains, and automobiles. Mobile network systems have traditionally been limited in bandwidth and link capacity, making it prohibitively expensive and/or unacceptably slow to distribute such services to all passengers on a mobile platform. Certain limited services are currently available to mobile platform passengers. For example, a narrow-bandwidth Internet connection is available via a standard computer telephone modem between a user's computer and the air-ground or ship-shore telephony system. Another service is anticipated to provide world-wide-web content to users on a mobile platform. The web content, however, is pre-stored on a server located on the mobile platform and is updated while the platform is in an inactive mode, for example, when an aircraft is parked at an airport gate or when a ship is docked at a port.

A system for supplying television and data services to mobile platforms, described in co-pending U.S. patent application Ser. No. 09/639,912, provides bi-directional data transfer via satellite communications link between a ground-based control segment and a mobile RF transceiver system carried on each mobile platform. Each user on each mobile platform is able to interface with an on-board server by using a laptop, personal digital assistant (PDA) seat-back-mounted computer/display or other computing device. Each user can independently request and obtain Internet access, company intranet access and live television programming.

The above system also provides to mobile users data content that is implemented, for example, as a set of HTML pages housed on the on-board server. The content is kept fresh by periodic updates from a ground-based server and is available to a user via a private portal. The on-board server can be configured to accept user log-on information to support authentication and authorization of users, to keep track of user and network accounting information to support a billing system, and to transfer billing information to the ground-based control segment. The above system thus allows for individual customizing of content and billing for a particular user.

A system such as the one described above presents a mobile platform provider with a unique opportunity to communicate with its customers and to customize content, including advertising, to appeal to and assist a user in transit. For example, an airline could use such a system to provide an in-flight passenger with highly specific and timely information pertaining to the flight, the airport at which the flight is to land, and the passenger's destination. Although many passengers are likely to desire in-transit access to the Internet or to a company intranet, many passengers also would appreciate being able to view travel information and real-time television programming.

Accordingly, a customer interface would be desirable that provides a seated passenger with options to view, for example, live programming and travel information of interest as well as to access Internet or intranet service.

### SUMMARY OF THE INVENTION

In one embodiment, this invention provides a user-processor interface for providing data content to a user in transit on a mobile platform. The interface includes at least one option selectable by the user for bi-directional access to a network via satellite link. The interface also includes at least one option selectable by the user for real-time access to video content via satellite link. The user interface allows an in-flight passenger to select from an extensive menu of travel-related information, including up-to-date flight and ticketing information pertaining to the airline and aircraft carrying the passenger.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified block diagram illustrating a system for providing bi-directional data services and live television programming to mobile platforms;

FIG. 2 is a simplified block diagram of a mobile system carried on each mobile platform; and

FIG. 3 is a diagram illustrating a user-processor interface for providing data content to a user on a mobile platform.

### DETAILED DESCRIPTION OF THE PREFERRED EMBODIMENTS

The following description of the preferred embodiments is merely exemplary in nature and is in no way intended to limit the invention, its application, or uses.

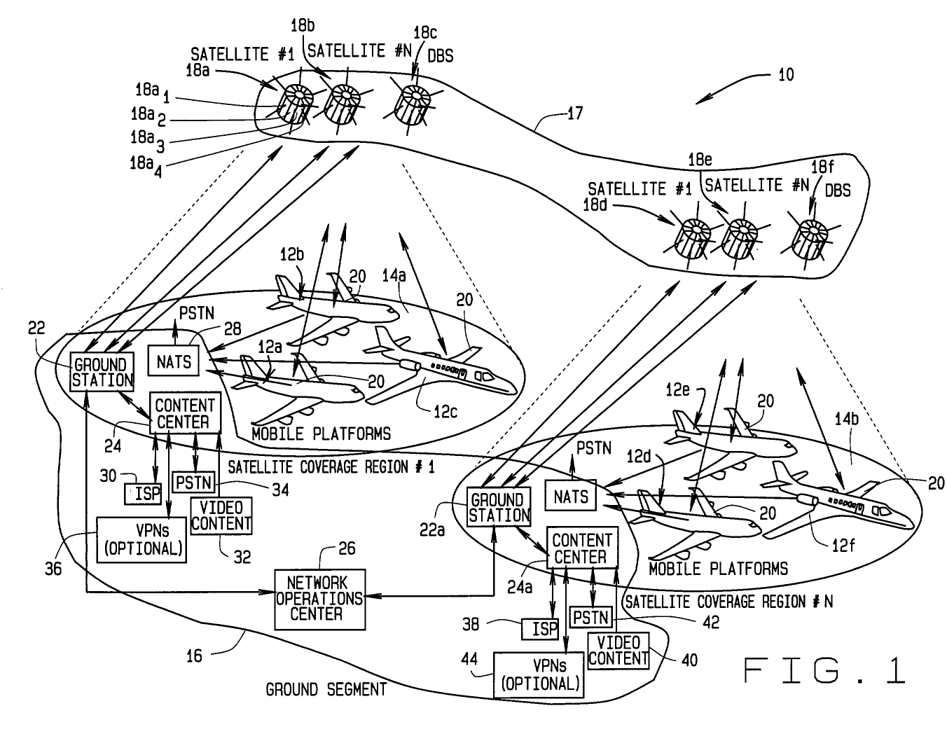

A system generally indicated in FIG. 1 by reference numeral 10 provides bi-directional data services and live television programming to mobile platforms 12a-12f in one or more coverage regions 14a and 14b. The system 10 includes a ground-based segment 16, a plurality of orbiting satellites 18a-18f, and a mobile system 20 disposed on each moving platform 12. Each mobile system 20 is in bi-directional communication with at least one of the satellites 18.

As described below, the present invention in one embodiment is directed to a user interface for providing data content from the system 10 to a user on one of the moving platforms 12. The moving platforms 12 could include aircraft, cruise ships or any other moving vehicle. Thus the illustration of the moving platforms 12 as aircraft herein, and the reference to the mobile platforms as aircraft throughout the following description, should not be construed as limiting the applicability of the system 10 and/or the present invention to only aircraft.

The ground segment 16 includes at least one ground station 22 in bi-directional communication with at least one of the satellites 18. The ground station 22 also is in bi-directional communication with an associated content center 24. Each ground station 22 also is in bi-directional communication with a network operations center (NOC) 26 via a terrestrial ground link or other suitable communication link. An optional air telephone system 28, e.g. the National Air Telephone System (NATS), may provide a return link from a mobile platform 12 alternative to that provided by the satellites 18.

The content center 24 in each coverage region 14 is in communication with a variety of external data content providers and controls the transmission of video and data information received by it to the associated ground station 22. The content center 24 is in contact, for example, with an Internet service provider (ISP) 30, a video content source 32 and a public switched telephone network (PSTN) 34. Optionally, the content center 24 can also communicate with one or more virtual private networks (VPNs) 36. As further described below and in accordance with one embodiment of the present invention, the ISP 30 provides Internet access to each of the occupants of aircraft 12a. The video content source 32 provides live television programming, for example, Cable News Network (CNN)® and ESPN®. The NOC 26 performs traditional network management, user authentication, accounting, customer service and billing tasks.

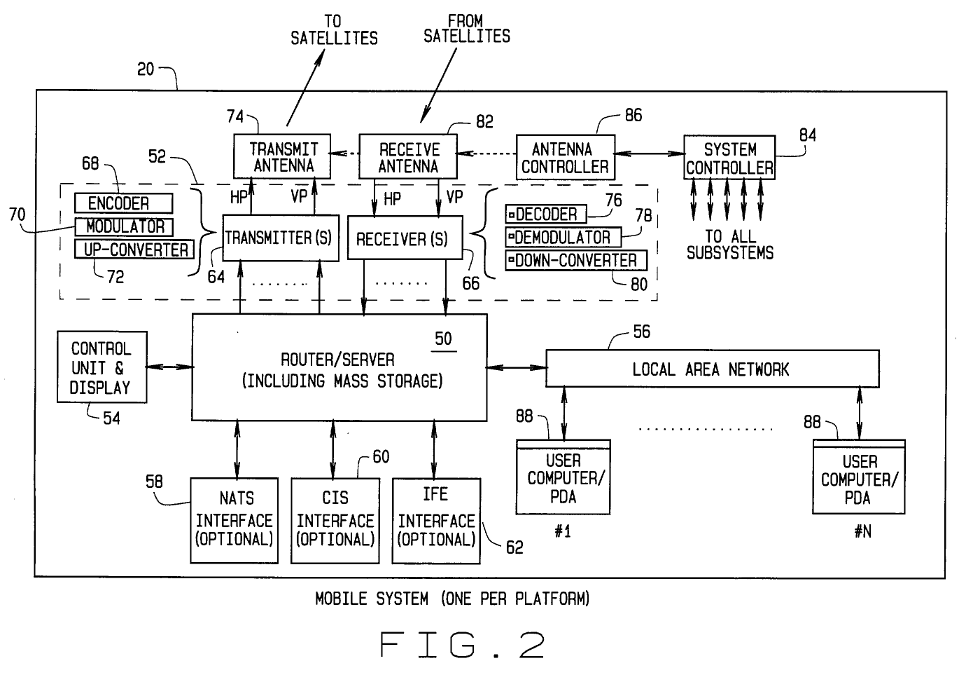

The mobile system 20 disposed on each aircraft 12 is described in FIG. 2. Each mobile system 20 includes a data content management system in the form of a router/server 50 (hereinafter “server”). The server 50 is in communication with a communications subsystem 52 that transmits signals to, and receives signals from, the satellites 18. Signals received via one of the satellites 18 could include Direct Broadcast Satellite (DBS) transmissions from such providers as DirecTV® and Echostar®.

The server 50 also is in communication with a control unit and display system 54 and a distribution system in the form of a local area network (LAN) 56. Optionally, the server 50 can also be configured for operation in connection with a National Air Telephone System (NATS) 58, a crew information services system 60 and/or an in-flight entertainment system (IFE) 62. The local area network (LAN) 56 is used to interface the server 50 to a plurality of access stations 88 associated with each seat location on board the aircraft 12. Each access station 88 can be used to provide direct two-way communication between the server 50 and a user's laptop computer, personal digital assistant (PDA) or other personal computing device of the user. The access stations 88 could also each include a seat-back-mounted computer/display. Such computer/display, laptop or other computing device used by the user is referred to herein as a “processor”.

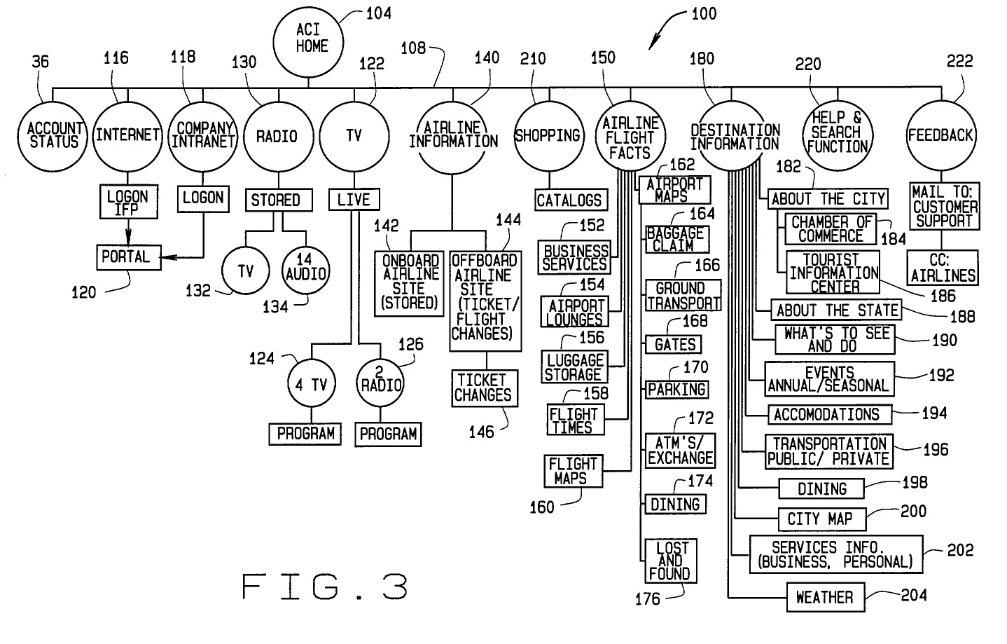

One embodiment of a user-processor interface 100 for providing data content to the user on a moving platform, e.g. the aircraft 12a, is shown in FIG. 3. The interface 100 is configured as a set of HTML pages stored in the on-board server 50 and available to all users in transit on the aircraft 12a. The interface 100 includes a home page 104 displaying a menu 108 of options selectable by the user using e.g. a mouse or touch-pad.

As further described below, an option 116 provides the user with Internet access and an option 118 provides for access to a company intranet. Options 116 and 118 provide for bi-directional access to their respective networks via satellite link. When selected by the user, each of the options 116 and 118 provides access to a private in-transit portal 120, from which the appropriate network is accessed using log-on and billing information previously supplied by the user.

An option 122 provides real-time access to video content via satellite link. Thus the user can select from live television programming options 124 and radio programming options 126 while in flight on the aircraft 12a. Additionally, an option 130 allows the user to access video content 132 and audio content 134 stored in the on-board server 50. Pay-per-view video, custom programming provided by the airline operating the aircraft 12a, and listings of radio and television schedules are examples of content that can be made available to the user through the options 122 and 130.

An option 136 allows the user to review billing, credit card, and other account information previously entered by the user, for example, to request pay-per-view services or to access the Internet or an intranet via the private portal 120. The account status option 136 also could display statistics of interest to the user, for example, network connect times, pay-per-view programming purchased and other quantities relevant to billing and system access by the user.

As further described below, one or more options are selectable by the user for accessing travel-related content. Such content can be tailored to relate to a specific destination, a specific airline, a specific aircraft, and/or a specific user, e.g. an occupant of a specific seat location on the aircraft 12a. The content is stored in the on-board server 50 and can be refreshed by periodic in-flight updates via satellite link.

An option 140, for example, is configured to provide airline information 142, including aircraft scheduling and ticket information, stored in the server 50. Scheduling information could pertain to connecting flights for passengers on board the aircraft 12a and could pertain to more than one airline. During flight of the aircraft 12a, any changes 144 to the scheduling and ticket information can be received from the ground station 22 via satellite link and included in the information available to the user. Where passengers are assigned specific seat locations, ticket change information 146 pertaining individually to a passenger can be made available via the passenger's associated access station 88.

Another option 150 is configured to provide flight information tending to be less time-sensitive than the scheduling information 142 and 144. Such information pertains, for example, to airports or other terminals to which the user is to travel. The user thus can become informed as to such topics as business services 152, airport lounges 154, luggage storage 156, generalized flight schedules 158, flight maps 160, airport maps 162, baggage claim areas 164, ground transport facilities 166, gate locations 168, parking areas 170, automated teller machines and currency exchange 172, dining locations 174 and lost-and-found departments 176.

An option 180 provides information about a destination of the mobile platform 12a. Such information can describe a city 182, a chamber of commerce 184, a tourist information center 186, a state 188, a “what to see and do” list of items 190, annual and seasonal events 192, accommodations 194, public/private transportation 196, dining 198, a city map 200, business/personal services 202 and weather 204. Information such as weather that is subject to change can be updated via satellite link as previously described. Thus, for example, a user expecting to spend time in the selected destination can keep abreast of conditions and become informed as to events and facilities before arriving in the destination.

Another option 210 provides the user with access to on-line shopping catalogs stored in the server 50 and offered, for example, by an airline operating the aircraft 12a. The user can shop while in flight, and billing information can be made available to the user via the account status option 136. Other content such as magazines and newspapers also could be stored in the server 50 for access by the user. A help and search function 220 permits the user to search, for example, the digital content that is stored on the server 50 and available through the interface 100. A feedback option 222 allows the user to contact, for example, a content provider and/or airline.

The above described user interface of the present invention is easy to use and can provide an in-flight airline passenger with a select menu of entertainment, up-to-date flight and destination information, and shopping content. Additionally, the interface and the content can be customized according to the needs of the particular airline or mass transit carrier.

The options available via the interface 100 as shown in FIG. 3 are exemplary only, and many other options are possible within the spirit and scope of the present invention. It can be appreciated that the interface 100 also can be used to provide data content to users on other moving platforms, including but not limited to ships, trains and buses.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A user-processor interface for providing data content to a user in transit on a mobile platform, said interface comprising at least one option for bi-directional access to a communications network via satellite link, said interface further comprising at least one option for real-time access to video content via satellite link, said options being selectable by the user.

2. An interface in accordance with claim 1 wherein said option for bi-directional access to a network via satellite link, when selected by the user, provides user access to a private in-transit portal from which the network is accessed.

3. An interface in accordance with claim 1 wherein said option for bi-directional access to a network comprises an option to access the Internet.

4. An interface in accordance with claim 1 wherein said option for bi-directional access to a network comprises an option to access an intranet.

5. An interface in accordance with claim 1 wherein real-time access to video content comprises real-time access to television and radio programming.

6. An interface in accordance with claim 1 further comprising options selectable by the user to access video and audio content stored in an on-board server.

7. An interface in accordance with claim 1 further comprising an option selectable by the user to view the status of a user account.

8. An interface in accordance with claim 1 further comprising at least one option selectable by the user for accessing travel-related content.

9. An interface in accordance with claim 8 wherein said at least one option for accessing travel-related content comprises an option for accessing information pertaining to at least one mobile platform provider.

10. An interface in accordance with claim 9 wherein said information pertaining to at least one mobile platform provider comprises mobile platform scheduling information.

11. An interface in accordance with claim 8 wherein said at least one option for accessing travel-related content comprises an option for accessing information pertaining individually to the user.

12. An interface in accordance with claim 11 wherein said information pertaining individually to the user comprises mobile platform ticketing information.

13. An interface in accordance with claim 8 wherein said options for accessing travel-related content are configured to provide access to information stored in an on-board server.

14. An interface in accordance with claim 8 wherein said options for accessing travel-related content are configured to provide access to information updated via satellite link while the mobile platform is in transit.

15. An interface in accordance with claim 8 wherein said at least one option for accessing travel-related content is configured to provide information relating to a terminal to which the user is to travel.

16. An interface in accordance with claim 8 wherein said at least one option for accessing travel-related content comprises an option for accessing information relating to a destination of the user.

17. An interface in accordance with claim 8 wherein said at least one option for accessing travel-related content comprises an option for accessing at least one on-line shopping catalog.

18. An interface in accordance with claim 8 wherein said content selectable by the user is customized to relate to a mobile platform provider.

19. An interface for providing informational content to a user on a moving platform via a local area network on the moving platform, the local area network having bi-directional access to content via at least one satellite, said interface comprising:
at least one option to access content stored on the server; and
at least one option to access content available via the at least one satellite, said options selectable by the user.

20. An interface in accordance with claim 19 wherein said content available via the at least one satellite comprises video content accessible by the user in real time.

21. An interface in accordance with claim 19 wherein said content available via the at least one satellite comprises content available via the Internet.

22. An interface in accordance with claim 19 wherein said content available via the at least one satellite comprises content available via an intranet.

23. An interface in accordance with claim 19 wherein said options selectable by the user comprise at least one option for accessing travel-related information.

24. An interface in accordance with claim 23 wherein said at least one option for accessing travel-related information comprises an option for accessing mobile platform information stored on the server and updated via the at least one satellite.

25. An interface in accordance with claim 23 wherein said at least one option for accessing travel-related information comprises an option for accessing information relating to a destination of the moving platform.

26. An interface in accordance with claim 25 wherein information relating to a destination comprises information relating to one of a city, a chamber of commerce, a tourist information center, a state, a listing of places and activities, events, accommodations, transportation, dining, a city map, services, and weather.

27. An interface in accordance with claim 23 wherein said at least one option for accessing travel-related information comprises an option for accessing information relating to at least one airport.

28. An interface in accordance with claim 27 wherein information relating to at least one airport comprises information relating to one of business services, airport lounges, luggage storage, flight times, flight maps, airport maps, baggage claim, ground transport, gates, parking, automated teller machines, currency exchange, dining, and lost-and-found-departments.

29. A method of providing access, by a plurality of users on board a moving platform, to data content available from an on-board server and via a satellite link, each of the users having access to the server using a processor, said method comprising the steps of:
providing at least one option to each user for accessing content stored on the server; and
providing at least one option to each user for accessing video content in real time via the satellite link,
said steps being performed using a user-processor interface stored on the server.

30. A method in accordance with claim 29 further comprising the step of customizing the user-processor interface to relate to a moving platform provider.

31. A method in accordance with claim 29 further comprising the step of customizing the data content to relate to a moving platform provider.
